(19) United States
(12) Patent Application Publication
(10) Pub. No.: US 2026/0241782 A1
(43) Pub. Date: Aug. 20, 2026

(54) DRIVE APPARATUS FOR VEHICLE

(71) Applicant: TOYOTA JIDOSHA KABUSHIKI KAISHA, Toyota-shi (JP)

(72) Inventors: Satoru ITO, Mishima-shi (JP); Hirotsugu YOSHINO, Numazu-shi (JP); Takeshi KITAYAMA, Sunto-gun (JP); Daiki KURIHARA, Atsugi-shi (JP)

(73) Assignee: TOYOTA JIDOSHA KABUSHIKI KAISHA, Toyota-shi (JP)

(21) Appl. No.: 19/535,062

(22) Filed: Feb. 10, 2026

(30) Foreign Application Priority Data
Feb. 18, 2025 (JP) 2025-024596

(51) Int. Cl. B60K 6/26; B60K 6/44

(52) U.S. Cl. CPC B60K 6/26; B60K 6/44; B60K 2006/262

(57) ABSTRACT

A vehicle drive apparatus includes an electric motor, an engagement device and a switch mechanism. The electric motor includes a stator, a rotor shaft and a rotor core disposed between the stator and the rotor shaft and including a fixed rotor core and a pivotable rotor core. A phase difference between the fixed rotor core and the pivotable rotor core of the electric motor is determined depending on whether the electric motor is in a different pole state or a same pole state. The switch mechanism is configured to place the engagement device into one of connection and disconnection states in conjunction with the phase difference when the first electric motor is in the different pole state, and is configured to place the engagement device into another of the connection and disconnection states in conjunction with the phase difference when the first electric motor is in the same pole state.

This application claims priority from Japanese Patent Application No. 2025-024596 filed on Feb. 18, 2025, the disclosure of which is herein incorporated by reference in its entirety.

### FIELD OF THE INVENTION

The present invention relates to a drive apparatus for a vehicle, which includes an electric motor, an engagement device and a switch mechanism configured to switch an operation state of the engagement device in conjunction with a drive state of the electric motor.

### BACKGROUND OF THE INVENTION

There is known a vehicle drive apparatus that includes an electric motor, an engagement device and an actuator configured to switch an operation state of the engagement device. For example, a vehicle drive apparatus described in Patent Document 1 is such a drive apparatus.

### PRIOR ART DOCUMENT

### Patent Document

[Patent Document 1] JP 2013-67262 A

### SUMMARY OF THE INVENTION

In the drive apparatus of the vehicle described in Patent Document 1, a control unit controls a hydraulic linear actuator to switch the operation state of the engagement device, thereby allowing or inhibiting rotation of a rotor shaft of the electric motor. In this way, an actuator controlled by the control unit is required to switch the operation state of the engagement device.

The present invention was made against the background of the above circumstances, and its purpose is to provide a drive apparatus for a vehicle, which does not require an actuator and is equipped with a switch mechanism configured to switch an operation state of an engagement device in conjunction with a drive state of an electric motor.

According to the present invention, there is provided a drive apparatus for a vehicle. The drive apparatus includes: (i) a first electric motor including a cylindrical stator disposed on an axis, a rotor shaft disposed on an inner peripheral side of the stator and extending in a direction of the axis, and a rotor core disposed between the stator and the rotor shaft and including a permanent magnet; (ii) an engagement device including a first member connected to the rotor shaft and unrotatable relative to the rotor shaft and a second member that is to be selectively connected to and disconnected from the first member; and (iii) a switch mechanism configured to switch an operation state of the engagement device between connection and disconnection states in conjunction with a drive state of the first electric motor, such that the second member is connected to the first member in the connection state, and such that the second member is disconnected from the first member in the disconnection state. The rotor core includes a fixed rotor core fixed to the rotor shaft and unrotatable relative to the rotor shaft about the axis and a pivotable rotor core disposed adjacent to the fixed rotor core in the direction of the axis and pivotable relative to the fixed rotor core withing a predetermined angle range about the axis. The drive sate of the first electric motor is to be switched, in accordance with an output torque of the first electric motor, between a different pole state and a same pole state, such that magnetic poles appearing on respective surfaces of the fixed rotor core and the pivotable rotor core, which are adjacent to each other in the direction of the of the axis, are different poles from each other in the different pole state, and such that the magnetic poles appearing on the respective surfaces are the same poles as each other in the same pole state. A phase difference between the fixed rotor core and the pivotable rotor core is determined in accordance with the drive state of the first electric motor. The switch mechanism is configured to place the engagement device into one of the connection and disconnection states in conjunction with the phase difference when the first electric motor is in the different pole state, and is configured to place the engagement device into another of the connection and disconnection states in conjunction with the phase difference when the first electric motor is in the same pole state.

In the drive apparatus according to the present invention, (a) the rotor core includes the fixed rotor core fixed to the rotor shaft and unrotatable relative to the rotor shaft about the axis and the pivotable rotor core disposed adjacent to the fixed rotor core in the direction of the axis and pivotable relative to the fixed rotor core within the predetermined angle range about the axis, (b) the drive sate of the first electric motor is to be switched, in accordance with an output torque of the first electric motor, between a different pole state and a same pole state, such that magnetic poles appearing on respective surfaces of the fixed rotor core and the pivotable rotor core, which are adjacent to each other in the direction of the of the axis, are different poles from each other in the different pole state, and such that the magnetic poles appearing on the respective surfaces are the same poles as each other in the same pole state, (c) the phase difference between the fixed rotor core and the pivotable rotor core is determined in accordance with the drive state of the first electric motor, and (d) the switch mechanism is configured to place the engagement device into one of the connection and disconnection states in conjunction with the phase difference when the first electric motor is in the different pole state, and is configured to place the engagement device into another of the connection and disconnection states in conjunction with the phase difference when the first electric motor is in the same pole state. With the constructions (a) and (b), the first electric motor is switched between the different pole state and the same pole state in accordance with its output torque. With the constructions (c) and (d), the switch mechanism switches the operation state of the engagement device between the connection and disconnection states in conjunction with the phase difference between the fixed rotor core and the pivotable rotor core. Since the switch mechanism is operated in conjunction with the phase difference between the fixed rotor core and the pivotable rotor core, the drive apparatus is capable of causing the operation state of the engagement device to be switched in conjunction with the drive state of the first electric motor, without needing an actuator.

### BRIEF DESCRIPTION OF THE DRAWINGS

FIG. 1 is a schematic view of a vehicle equipped with a drive apparatus according to a first embodiment of the present invention, and also a view showing main parts of control functions for various controls in the vehicle.

FIGS. 2A-2C are views for explaining a construction of a first electric motor, wherein FIG. 2A shows a different pole state, FIG. 2B shows a positive-side same pole state, and FIG. 2C shows a negative-side same pole state.

FIGS. 3A and 3B are views for explaining an operation state of SOWC, wherein FIG. 3A shows a free state, and FIG. 3B shows a one-way lock state.

FIGS. 4A-4F are collinear charts for showing respective driving modes of the vehicle, wherein FIG. 4A shows a case in which an engine is started, FIG. 4B shows a case in which the vehicle is in BEV driving mode with a second electric motor as a power source, FIG. 4C shows a case in which the vehicle is in HEV driving mode with a first electric motor locked, FIG. 4D shows a case in which the vehicle enters a low-μ road during running of the vehicle in the HEV driving mode with the first electric motor locked, FIG. 4E shows a case in which the vehicle exits the low-μroad in a state of FIG. 4D, and FIG. 4F shows a case in which the vehicle runs in a reverse direction in the BEV driving mode with the second electric motor as the power source in occurrence of a failure by which the SOWC is locked in the one-way lock state.

FIG. 5 is a schematic view of a part of a drive apparatus according to a second embodiment of the present invention.

FIGS. 6A and 6B are views for explaining a construction of a dog clutch, wherein FIG. 6A shows a non-pressing state of a biasing device and FIG. 6B shows a pressing state of the biasing device.

### DETAILED DESCRIPTION OF PREFERRED EMBODIMENTS

Hereinafter, preferred embodiments of the present invention will be described in detail with reference to the drawings. It is noted that, unless otherwise specified, drawings in each embodiment have been appropriately simplified or modified, and dimensional ratios and shapes of each part are not necessarily accurately depicted. In the present specification, “circumferential direction around on a first axis C1” will be simply referred to as the “circumferential direction”.

### FIRST EMBODIMENT

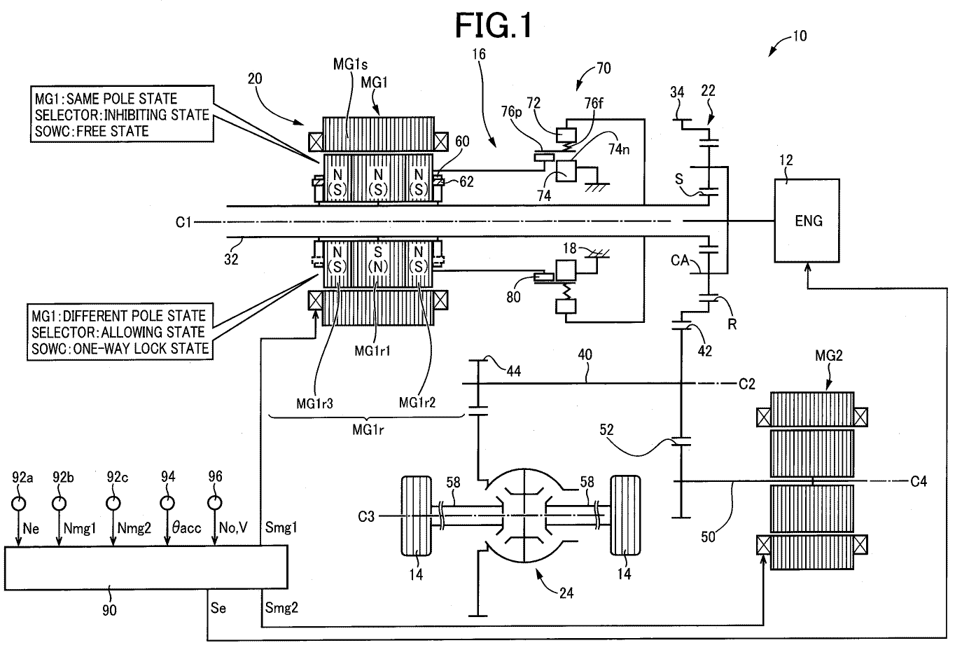

FIG. 1 is a schematic view of a vehicle 10 equipped with a drive apparatus 20 according to a first embodiment of the present invention, and is a view showing main parts of control functions for various controls in the vehicle 10.

The vehicle 10 is, for example, a hybrid electric vehicle equipped with an engine 12, a first electric motor MG1 and a second electric motor MG2 as power sources. The vehicle 10 is equipped with a power transmission device 16 on a power transmission path between these power sources and a pair of dive wheels 14. The power transmission device 16 is equipped with, in order from the engine 12 side, a planetary gear device 22, a first drive gear 34, a large diameter gear 42, a counter shaft 40, a small diameter gear 44 and a differential gear device 24 in a casing 18 on the power transmission path between the engine 12 and the pair of dive wheels 14, each of which has a known construction. The casing 18 is a known casing made of an unrotatable member with an oil-tight sealed structure. The power transmission device 16 is equipped with a pair of axles 58 of a known construction between the differential the differential gear device 24 and the pair of dive wheels 14. A first axis C1 is a rotational center line of the engine 12, planetary gear device 22 and first drive gear 34, and corresponds to “axis” in this invention. A econd axis C2 is a rotational center line of the large diameter gear 42, counter shaft 40, and small diameter gear 44. A third axis C3 is a rotational center line of the differential gear device 24, the pair of axles 58 and the pair of dive wheels 14.

The second electric motor MG2 is a so-called motor generator, such as a well-known three-phase synchronous motor generator. The power transmission device 16 is provided on the power transmission path between the second electric motor MG2 and the large diameter gear 42, and is equipped, in this order from the second electric motor MG2 side, with a second rotor shaft 50, which is an output shaft of the second electric motor MG2, and a second drive gear 52, each of which has a well-known construction. In this way, the second electric motor MG2 is connected to the power transmission path between the planetary gear device 22 and the pair of dive wheels 14 in a power transmittable manner. A fourth axis C4 is a rotational center line of the second electric motor MG2, the second rotor shaft 50, and the second drive gear 52.

The vehicle 10 is equipped with an electronic control apparatus 90. The electronic control apparatus 90 includes, for example, a so-called microcomputer, and performs various controls of vehicle 10 by processing signals in accordance with pre-stored programs. The electronic control apparatus 90 receives, for example, various signals (e.g., engine rotational speed Ne [rpm], MG1 rotational speed Nmg1 [rpm], MG2 rotational speed Nmg2 [rpm], accelerator opening degree θacc [%] which is an amount of accelerator operation indicating a magnitude of driver's acceleration operation, vehicle speed V [km/h], etc.) based on detection values from various sensors (e.g., rotational speed sensor 92a, rotational speed sensor 92b, rotational speed sensor 92c, accelerator opening-degree sensor 94, vehicle speed sensor 96, etc.). Is noted that the engine rotational speed Ne, MG1 rotational speed Nmg1, MG2 rotational speed Nmg2 are a rotational speed of the engine 12, a rotational speed of the first electric motor MG1 and a rotational speed of the second electric motor MG2, respectively. From the electronic control apparatus 90, various control signals (such as an engine control signal Se that controls the operation state of the engine 12, and an MG1 control signal Smg1 and an MG2 control signal Smg2 that control operation states of the first electric motor MG1 and the second electric motor MG2 via an inverter not shown) are outputted to each device of the vehicle 10 (engine 12, first electric motor MG1, second electric motor MG2, etc.). In this way, the engine rotational speed Ne, engine torque Te [N·m], MG1 rotational speed Nmg1, MG1 torque Tmg1 [N·m], MG2 rotational speed Nmg2 and MG2 torque Tmg2 [N·m] are controlled by the electronic control apparatus 90. The engine torque Te, MG1 torque Tmg1 and MG2 torque Tmg2 are an output torque of engine 12, an output torque of first electric motor MG1 and an output torque of second electric motor MG2, respectively. The MG1 torque Tmg1 corresponds to “output torque” in this invention. In this specification, torque, driving force, motive power and force (=power) are synonymous unless otherwise distinguished.

The engine 12 is a well-known internal combustion engine. The planetary gear device 22 is a power split mechanism that mechanically splits the power outputted from the engine 12 to the first electric motor MG1 and the first drive gear 34. The engine 12 and the first electric motor MG1 are connected to the planetary gear device 22, such that engine torque Te can be split to the first electric motor MG1 and the first drive gear 34 connected to the pair of dive wheels 14. For example, the planetary gear device 22 is a single pinion type, and the first electric motor MG1, engine 12 and first drive gear 34 are connected to the sun gear S, carrier CA, and ring gear R, respectively. The engine torque Te corresponds to “engine power” in this invention.

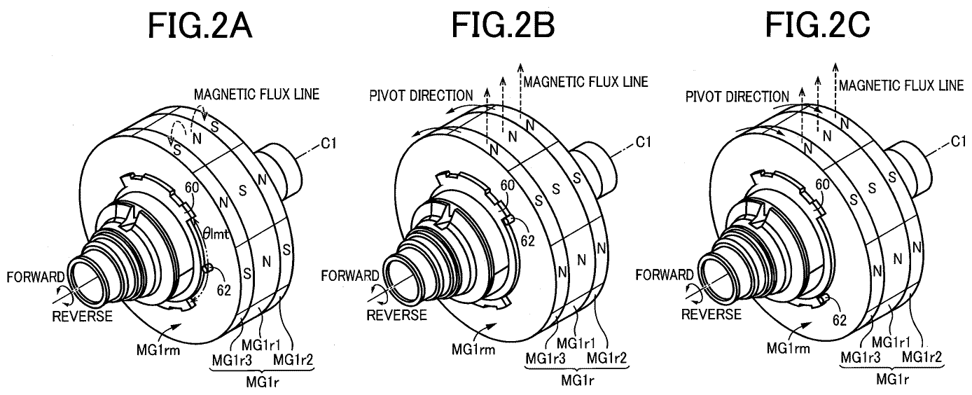

The first electric motor MG1 is a so-called motor-generator, for example, a three-phase synchronous motor-generator. The first electric motor MG1 has a cylindrical stator MG1s disposed to be centered on the first axis C1, a first rotor shaft 32 disposed on an inner peripheral side of the stator MG1s and extending in a direction of the first axis C1, and a rotor core MG1r diposed between the stator MG1s and the first rotor shaft 32 and including a permanent magnet MG1rm (see FIG. 2). The first rotor shaft 32 corresponds to “rotor shaft” in this invention. The rotor core MG1r includes a fixed rotor core MG1r1 fixed to the first rotor shaft 32 and unrotatable relative to the first rotor shaft 32 and pivotable rotor cores MG1r2, MG1r3 disposed adjacent to opposite sides of the fixed rotor core MG1r1 in the direction of the first axis C1. Unless otherwise distinguished, the pivotable rotor core MG1r2 and the pivotable rotor core MG1r3 are referred to as “pivotable rotor cores MG1r2, MG1r3”. The fixed rotor core MG1r1 and the pivotable rotor cores MG1r2, MG1r3 all have the same number of magnetic poles (eight in this embodiment) that appear on their surfaces due to the permanent magnets MG1rm, and the magnetic poles are arranged at equal angular intervals in the circumferential direction (π/4 [rad] intervals in this embodiment). The pivotable rotor cores MG1r2, MG1r3 are rotatable relative to the fixed rotor core MG1r1 in the circumferential direction within a predetermined angular range θlmt [rad]. The predetermined angular range θlmt will be described later.

FIGS. 2A-2C are views for explaining a construction of a first electric motor, wherein FIG. 2A shows a different pole state, FIG. 2B shows a positive-side same pole state, and FIG. 2C shows a negative-side same pole state. Hereinafter, unless otherwise specified, a positive-side same pole state and a negative-side same pole state will be referred to as “same pole state”.

FIG. 2A shows a case in which the absolute value of the MG1 torque Tmg1 is less than a release torque value Tmg1_rel (|Tmg1|<Tmg1_rel). In this case, the first electric motor MG1 is in the different pole state in which a magnetic pole appearing on a surface of the fixed rotor core MG1r1 and a magnetic pole appearing on a surface of each of the pivotable rotor cores MG1r2, MG1r3, which are adjacent to each other in the direction of the axis C1, are different poles from each other. The different pole state is established by an attractive force between the different poles of the fixed rotor core MG1r1 and each of the pivotable rotor cores MG1r2, MG1r3 and a repulsive force between the same poles of the fixed rotor core MG1r1 and each of the pivotable rotor cores MG1r2, MG1r3. FIG. 2B shows a case in which the MG1 torque Tmg1 acting in a direction for moving the vehicle 10 in a forward direction is larger than or equal to the release torque value Tmg1_rel (Tmg1≥Tmg1_rel>0). In this case, the first electric motor MG1 is in a positive-side same-pole state in which the magnetic pole appearing on the surface of fixed rotor core MG1r1 and the magnetic pole appearing on the surface of each of the pivotable rotor cores MG1r2, MG1r3, which are adjacent to each other in the direction of the first axis C1, are same poles as each other. FIG. 2C shows a case in which an absolute value of the MG1 torque Tmg1 acting in a direction for moving the vehicle 10 a reverse direction is larger than or equal to the release torque value Tmg1_rel (Tmg1≤-Tmg1_rel<0). In this case, the first electric motor MG1 is in a negative-side same-pole state in which the magnetic poles that appear on the surfaces of the fixed rotor core MG1r1 and each of the pivotable rotor cores MG1r2, MG1r3, which are adjacent to each other in the direction of the first axis C1, are same poles as each other.

Here, a relative rotation angle of each of the pivotable rotor cores MG1r2 MG1r3 relative to the fixed rotor core MG1r1 is referred to as a phase difference Δθ [rad]. The phase difference Δθ in the different pole state is set to zero. The phase difference Δθ in the positive-side same pole state is set to positive, and the phase difference Δθ in the negative-side same pole state is set to negative. Here, the phase difference Δθ when the first electric motor MG1 is in the different pole state is referred to as a phase difference Δθdif, and the phase difference Δθ when the first electric motor MG1 is in the same pole state is referred to as a phase difference Δθsame.

The larger the absolute value of MG1 torque Tmg1, the larger a rotating magnetic field generated by the stator MG1s. When the rotating magnetic field becomes larger, the pivotable rotor cores MG1r2, MG1r3 are rotated in a direction by which the MG1 torque Tmg1 is applied by the attractive and repulsive forces of the rotating magnetic field of the stator MG1s, against the attractive and repulsive forces between the different poles and the same poles between the magnetic poles of the fixed rotor core MG1r1 and the magnetic poles of the pivotable rotor cores MG1r2, MG1r3. The “release torque value Tmg1_rel” is a predetermined lower limit of the absolute value of MG1 torque Tmg1 at which the first electric motor MG1 is switched from the different pole state to the same pole state. In this way, the first electric motor MG1 is switched among the different pole state, the positive-side same pole state and the negative-side same pole state, in accordance with the MG1 torque Tmg1. In FIG. 1, an area on an upper side of the first axis C1 represents the same pole state of the first electric motor MG1, and an area on a lower side of the first axis C1 represents the different pole state of first electric motor MG1.

Two disk-shaped stoppers 60 (see FIG. 1) are fixed to the first rotor shaft 32 so as not to rotate relative to each other. The two stoppers 60 are rotated synchronously with the fixed rotor core MG1r1 via the first rotor shaft 32. The two stoppers 60 are fixed adjacent to the two pivotable rotor cores MG1r2, MG1r3, such that each of the two stoppers 60 is located on an opposite side of the fixed rotor core MG1r1 in the direction of the first axis C1. Pins 62 that protrude toward the stoppers 60 in the direction of the first axis C1 are fixed to the pivotable rotor cores MG1r2, MG1r3. A cutout is provided on an outer periphery of each of the stoppers 60 so as to limit a relative rotation angle (=phase difference) of a corresponding one of the pins 62 relative to each of the stoppers 60 to a predetermined angle range θlmt in the circumferential direction, and the corresponding one of the pins 62 is engaged in the cutout. The predetermined angular range θlmt is set to, for example, three times an equiangular interval at which the magnetic pole of each of the fixed rotor core MG1r1 and pivotable rotor cores MG1r2, MG1r3 appears in the circumferential direction (in this embodiment, the predetermined angular range θlmt is set to 3π/4 [rad]). In the positive-side same pole state of FIG. 2B, the pin 62 is pressed against one end of the cutout of the stopper 60 in the circumferential direction. In the negative-side same pole state of FIG. 2C, the pin 62 is pressed against the other end of the cutout of stoppers 60 in the circumferential direction. In these same pole states, the pivotable rotor cores MG1r2, MG1r3 contribute to the output of the MG1 torque Tmg1 to the first rotor shaft 32 through the pins 62 and the stoppers 60. In the different pole state of FIG. 2A, the pin 62 is located in a center portion of the cutout of stoppers 60 in the circumferential direction. In the different pole state, the pivotable rotor cores MG1r2, MG1r3 do not contribute to the output of the MG1 torque Tmg1 to the first rotor shaft 32 through the pins 62 and the stoppers 60. In this way, the pins 62 and the stoppers 60 are fixed such that the pin 62 is positioned in one of the above-described positions relative to the cutout of stopper 60 depending on the positive-side same pole state, negative-side same pole state and different pole state. The phase difference Δθ between the fixed rotor core MG1r1 and each of the pivotable rotor cores MG1r2, MG1r3 is determined depending on the drive state of the first electric motor MG1 (=positive-side same pole state, different pole state, negative-side same pole state).

Referring back to FIG. 1, the power transmission device 16 includes an SOWC 70 and a selector 80. The SOWC 70 is a selectable one-way clutch. The SOWC 70 includes an outer ring 72 connected to the first rotor shaft 32 so as not to be rotatable relative to the first rotor shaft 32, an inner ring 74 that is to be selectively connected to and disconnected from the outer ring 72, and a plurality of connection/disconnection devices 76. The SOWC 70, the outer ring 72, and the inner ring 74 correspond to the “engagement device”, “first member” and “second member” in this invention, respectively. The outer ring 72 and the inner ring 74 correspond to the “one of the first member and the second member” and the “other of the first member and the second member”, respectively. Eighteen connection/disconnection devices 76 are provided at equal angular intervals (π/10 [rad] in this embodiment) on an inner peripheral side of the outer ring 72. Each of the connection/disconnection devices 76 includes a recess 76s provided in an inner periphery of the outer ring 72 and extending toward an outer periphery of the outer ring 72, and a pawl 76p biased by a spring 76f provided within the recess 76s so as to protrude toward the inner ring 74. The pawl 76p corresponds to “protrusion portion” in this invention. The pawl 76p protrudes from the outer ring 72 toward a selector 80 (described later) in the direction of the first axis C1. The inner ring 74 is connected to the casing 18. A plurality of grooves 74n (=notches) extending in the direction of the first axis C1 are provided on an outer periphery of the inner ring 74 and are arranged in the circumferential direction. When the pawls 76p protrude from the outer ring 72 toward the inner ring 74, the pawls 76p are brought into engagement with the grooves 74n whereby the SOWC 70 is placed in a one-way lock state by the connection/disconnection devices 76. When the pawls 76p of the connection/disconnection devices 76 do not protrude from the outer ring 72 towards the inner ring 74, the pawls 76p are not engaged with the grooves 74n, so that the SOWC 70 is placed in a free state. When the SOWC 70 is in the free state, the power is transmitted between the first electric motor MG1 and the sun gear S in both of the forward and reverse directions. When the SOWC 70 is in the one-way lock state, the power is transmitted between the first electric motor MG1 and the sun gear S only in the reverse direction. The forward direction is the direction of rotation when the vehicle 10 is moved in the forward direction, and the reverse direction is the direction of rotation when the vehicle 10 is moved in the reverse direction. In FIG. 1, the area on the upper side of the first axis C1 represents the free state of the SOWC 70, and the area on the lower side of the first axis C1 represents the one-way lock state of the SOWC 70. The one-way lock state and free state correspond to “one of the connection and disconnection states” and “another of the connection and disconnection states” respectively, in this invention.

The selector 80 switches the operation state of the SOWC 70 between the one-way lock state and the free state in conjunction with the drive state of the first electric motor MG1. The selector 80 corresponds to the “switch mechanism” in this invention. The “conjunction” means that the operation state of the SOWC 70 (dog clutch 170 in the second embodiment described below) is switched by mechanical connection, without requiring a control unit, i.e., an actuator controlled by the electronic control apparatus 90 described below. The “one-way lock state” is one of the operation states of the SOWC 70 that inhibits one direction of the relative rotation of the outer ring 72 relative to the inner ring 74. The “free state” is one of the operation states of the SOWC 70 that allows both directions of the relative rotation of the outer ring 72 relative to the inner ring 74. Since one of the drive state and the phase difference Δθ of the first electric motor MG1 is determined when the other is determined, switching in conjunction with the drive state of the first electric motor MG1 and switching in conjunction with the phase difference Δθ of the first electric motor MG1 are the same thing.

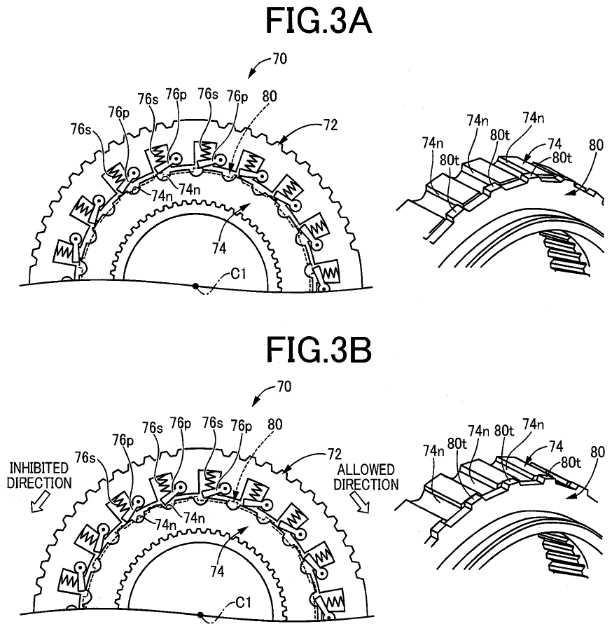

FIGS. 3A and 3B are views for explaining the operation state of SOWC, wherein FIG. 3A shows the free state, and FIG. 3B shows the one-way lock state. In each of FIGS. 3A and 3B, a left-side view is a view as seen from the outer and inner rings 72, 74 side toward the selector 80 side in the direction of the first axis C1, with the selector 80 indicated by broken line, and a right-side view is a perspective view of the inner ring 74 and selector 80 as seen from the selector 80 side. Eighteen opposed portions 80t are provided on the outer periphery of the selector 80, and protrude outwardly. The eighteen opposed portions 80t are arranged at equal angular intervals (π/10 [rad] in this embodiment), and correspond to the respective eighteen connection/disconnection devices 76 provided on the outer ring 72. The selector 80 is connected to the pivotable rotor core MG1r2 so as not to be rotated relative to the pivotable rotor core MG1r2. The selector 80 is rotated synchronously with the outer ring 72. With the phase difference Δθdif, the selector 80 is rotated such that the opposed portions 80t are positioned in respective positions in which all of the pawls 76p of the respective connection/disconnection devices 76 are inhibited from protruding. This rotation state of the selector 80 is referred to as “inhibiting state”. In the inhibiting state, none of the pawls 76p is engaged with the grooves 74n, so that the SOWC 70 is in the free state. With the phase difference Δθsame, the selector 80 is rotated such that the opposed portions 80t are positioned in respective positions in which all of the pawls 76p of the respective connection/disconnection devices 76 are allowed to protrude. This rotation state of the selector 80 is referred to as “allowing state”. In the allowing state, at least one of the pawls 76p is engaged with the groove 74n, so that the SOWC 70 is in the one-way lock state. The rotation of the outer ring 72 relative to the inner ring 74 in “INHIBITED DIRECTION” indicated in FIG. 3 is inhibited, while the rotation of the outer ring 72 relative to the inner ring 74 in “ALLOWED DIRECTION” indicated in FIG. 3 is allowed. In FIG. 1, the area on the upper side of the first axis C1 represents the inhibiting state of the selector 80, while the area on the lower side of the first axis C2 represents the allowing state of the selector 80.

The drive apparatus 20 is constituted by the above-described engine 12, first electric motor MG1, second electric motor MG2 and power transmission device 16, wherein the engine 12, first electric motor MG1 and second electric motor MG2 serve as power sources.

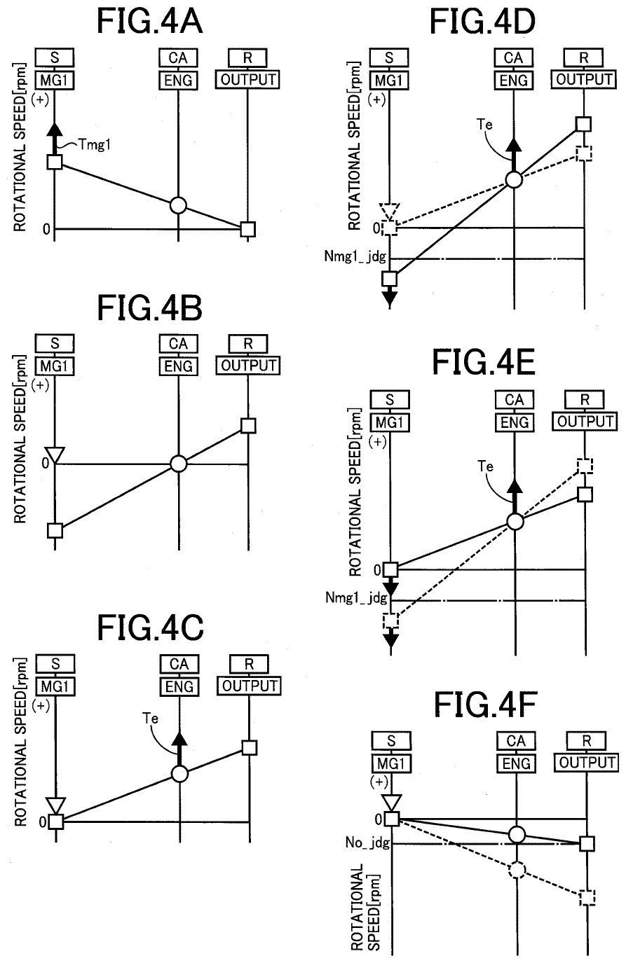

FIGS. 4A-4F are collinear charts for showing respective driving modes of the vehicle 10. In each of FIGS. 4A-4F shows relative rotational speeds of a sun gear S, a carrier CA and a ring gear R that are rotary elements of the planetary gear device 22. In each of FIGS. 4A-4F, “ENG” represents the engine 12, and “OUTPUT” represents the first drive gear 34 connected to the pair of dive wheels 14. Each arrow also indicates a direction of torque.

FIG. 4A shows a case in which the engine 12 is started. For example, increasing the MG1 the rotational speed Nmg1 cranks the engine 12, which is then ignited and started in conjunction with this cranking. In this case, the first electric motor MG1 is in a driving state, so that the first electric motor MG1 is in the positive-side same-pole state, the rotation state of the selector 80 is in the inhibiting state, and the SOWC 70 is in the free state. FIG. 4B shows a case in which the vehicle 10 is in BEV (Battery Electric Vehicle) driving mode (hereinafter referred to as “BEV_MG2 mode ”) with the second electric motor MG2 used as a power source. The BEV_MG2 mode is a driving mode that uses only the second electric motor MG2 as the power source for driving. In the BEV_MG2 mode, the engine 12 is stopped, and the first electric motor MG1 is in a non-driving state. In the BEV_MG2 mode, since the first electric motor MG1 is in the non-driving state, the first electric motor MG1 is in the different pole state, the rotation state of selector 80 is placed in the allowing state, and the SOWC 70 is placed in the one-way lock state. In other words, the first rotor shaft 32 connected to the outer ring 72 is restricted so that the first rotor shaft 32 is not rotated in the forward direction. As a result, the rotational speed of first drive gear 34 (hereinafter referred to as “output rotational speed No”) is increased in accordance with the MG2 rotational speed Nmg2. Since the engine 12 has a large inertia, the engine rotational speed Ne is maintained near zero. As a result, the MG1 rotational speed Nmg1 becomes a negative value. FIG. 4C is a case in which the vehicle 10 is in the HEV (Hybrid Electric Vehicle) driving mode with the first electric motor MG1 locked (hereinafter referred to as “HEV_MG1 lock mode”). The HEV_MG1 lock mode is a driving mode in which at least the engine 12, out of the engine 12 and the second electric motor MG2, is used as the power source for driving the vehicle 10. In the HEV_MG1 lock mode, the engine 12 is in the driving state while the first electric motor MG1 is in the non-drive state. In the HEV_MG1 lock mode, the first electric motor MG1 is in the different pole state, the rotation state of selector 80 is placed in the allowing state, and SOWC 70 is placed in the one-way lock state. As a result, the output rotational speed No [rpm] is determined in accordance with the engine rotational speed Ne.

FIG. 4D is a case in which the vehicle 10 enters a low-μroad during running of the vehicle 10 in the HEV_MG1 lock mode. The “low μroad” is a road such as an icy or gravel road where tires of the pair of dive wheels 14 are likely to slip. When the vehicle 10 enters the low μroad, the rotational speed of the pair of dive wheels 14 rises sharply, and accordingly, the output rotational speed No also rises sharply. It is noted that, since the inertia of the engine 12 is large, the engine rotational speed Ne is hardly changed. In other words, the relationship among the relative rotational speeds of the rotary elements of the planetary gear device 22 is changed from broken line to solid line, as shown in FIG. 4D. At this time, when the MG1 rotational speed Nmg1 is less than a predetermined speed judgment value Nmg1_jdg (Nmg1<Nmg1_jdg<0), the electronic control apparatus 90 controls the absolute value of the MG1 torque Tmg1 to be equal to or higher than the release torque value Tmg1_rel (|Tmg 1|≥Tmg1_rel >0), preferably, the electronic control apparatus 90 controls the absolute value of the MG1 torque Tmg1, which is a negative value, to be equal to or lower than the release torque value Tmg1_rel (Tmg1≤−Tmg1_rel<0). The MG1 torque Tmg1, which is set to be equal to or higher than the release torque value Tmg1_rel, is a reaction torque of the engine 12. This switches the rotation state of the selector 80 from the allowing state to the inhibiting state, and the SOWC 70 is switched from the one-way lock state to the free state. FIG. 4E is a case in which the vehicle 10 exits the low-μroad in the state of FIG. 4D. When the vehicle 10 exits the low μroad, the rotational speed of the pair of dive wheels 14 is returned to its original value, and accordingly, the output rotational speed No is also returned to zero. In other words, the relationship among the relative rotational speeds of the rotary elements of the planetary gear device 22 is changed from broken line to solid line as shown in FIG. 4E. At this time, the absolute value of the MG1 torque Tmg1 is set to be equal to or higher than the release torque value Tmg1_rel, and the SOWC 70 is placed in the free state. Therefore, even though the relationship is changed from the state indicated by the broken line to the state indicated by the solid line, an impact applied from the outer ring 72 to the inner ring 74 in the SOWC 70 is suppressed. For example, when the absolute value of the MG1 torque Tmg1 is not higher than or equal to the release torque value Tmg1_rel in the state of FIG. 4D, the SOWC 70 is maintained in the one-way lock state. In this case, as shown in FIG. 4E, the outer ring 72 of the SOWC 70 is moved from the reverse direction toward zero, thereby causing the pawls 76p protruding from the outer ring 72 toward the inner ring 74 to collide with the grooves 74n connected to the unrotatable member. This could damage the SOWC 70.

FIG. 4F shows a case in which the vehicle 10 runs in the reverse direction in BEV_MG2 in occurrence of a failure by which the SOWC 70 is locked in the one-way lock state. In this case, the output rotational speed No is in the reverse direction, and the forward direction of the MG1 rotational speed Nmg1 is inhibited. Therefore, the engine rotational speed Ne in the stopped state is in the reverse direction. As indicated by broken line, when the engine rotational speed Ne in the reverse direction becomes too high, engine 12 could be damaged if it is rotated without being supplied with lubricating oil. Therefore, as indicated by solid line, the absolute value of the output rotational speed No during running of the vehicle 10 in the reverse direction is limited to a predetermined speed judgment value No_jdg or less (|No|≤No_jdg), thereby preventing the engine rotational speed Ne in the reverse direction from becoming too high. The predetermined speed judgment value No_jdg is a predetermined judgment value that is determined experimentally or by design, at which there is no risk of damage to the engine 12 during running of the vehicle 10 in the reverse direction in the BEV_MG2 mode in the event of the failure that causes the SOWC 70 to be locked in the one-way lock state. Limiting the absolute value of the output rotational speed No to be equal to or less than the predetermined speed judgment value No_jdg is the same as limiting the vehicle speed V during running of the vehicle 10 in the reverse direction to be equal to or less than a predetermined vehicle speed value.

In the present embodiment, the drive apparatus 20 includes: (i) the first electric motor MG1 including the cylindrical stator MG1s disposed on the first axis C1, the first rotor shaft 32 disposed on the inner peripheral side of the stator MG1s and extending in the direction of the first axis C1, and the rotor core MG1r disposed between the stator MG1s and the first rotor shaft 32 and including the permanent magnet MG1rm; (ii) the SOWC 70 including the outer ring 72 connected to the first rotor shaft 32 and unrotatable relative to the first rotor shaft 32 and the inner ring 74 that is to be selectively connected to and disconnected from the outer ring 72; and (iii) the selector 80 configured to switch the operation state of the SOWC 70 between the connection and disconnection states in conjunction with the drive state of the first electric motor MG1, such that the inner ring 74 is connected to the outer ring 72 in the connection state, and such that the inner ring 74 is disconnected from the outer ring 72 in the disconnection state, wherein (a) the rotor core MG1r includes the fixed rotor core MG1r1 fixed to the first rotor shaft 32 and unrotatable relative to the first rotor shaft 32 about the first axis C1 and the pivotable rotor cores MG1r2, MG1r3 disposed adjacent to the fixed rotor core MG1r1 in the direction of the first axis C1 and pivotable relative to the fixed rotor core MG1r1 within the predetermined angle range θlmt about the first axis C1, (b) the drive sate of the first electric motor MG1 is to be switched, in accordance with the MG1 torque Tmg1, between the different pole state and the same pole state, (c) the phase difference Δθ between the fixed rotor core MG1r1 and the pivotable rotor cores MG1r2, MG1r3 is determined in accordance with the drive state of the first electric motor MG1, (d) the connection/disconnection device 76 is configured to place the outer and inner rings 72, 74 in the one-way lock state when the pawls 76p protrude from the outer ring 72 towards the inner ring 74, (e) the connection/disconnection device 76 is configured to place the outer and inner rings 72, 74 in the free state when the pawls 76p do not protrude from the outer ring 72 towards the inner ring 74, (f) the selector 80 is to be rotated in synchronization with the outer ring 72, and (g) the selector 80 is configured to allow and inhibit protrusion of the pawls 76p in conjunction of the phase difference Δθ. With the constructions (a) and (b), the first electric motor MG1 is switched between the different pole state and the same pole state in accordance with the MG1 torque Tmg1. With the constructions (ii), (c)-(e), the state of the first rotor shaft 32 connected to the outer ring 72 and the state of the inner ring 74 connected to the casing 18 are switched by the connection/disconnection devices 76. With the constructions (f) and (g), the selector 80 is configured to selectively allow and inhibit the protrusion of the pawls 76p of the connection/disconnection devices 76 in conjunction with the phase difference Δθ, so as to switch the connection and disconnection states of the outer and inner rings 72, 74, whereby the SOWC 70 is switched between the one-way lock state and the free state. Since the selector 80 is operated in conjunction with the phase difference Δθ, the drive apparatus 20 is capable of causing the operation state of the SOWC 70 to be switched in conjunction with the drive state of the first electric motor MG1, without needing an actuator.

In the present embodiment, (i) the drive apparatus 20 is provided with the first electric motor MG1, the SOWC 70, the selector 80, the engine 12, the second electric motor MG2 and the planetary gear device 22; (ii) the engine 12 and the first electric motor MG1 are connected to the planetary gear device 22 such that the engine torque Te can be power-split to the first electric motor MG1 and the first drive gear 34 connected to the pair of dive wheels 14; (iii) the second electric motor MG2 is connected to the power transmission path between the planetary gear device 22 and the pair of dive wheels 14 in a power transmittable manner; and (iv) the one-way lock state of the SOWC 70 inhibits the forward direction. As a result, as described with reference to FIGS. 4A-4F, the drive apparatus 20 realizes each driving mode of the vehicle 10, and also suppresses damage to the SOWC 70 and the engine 12 when the vehicle 10 enters or exiting a low μroad or when a failure occurs that causes the SOWC 70 to be locked in the one-way lock state.

SECOND EMBODIMENT

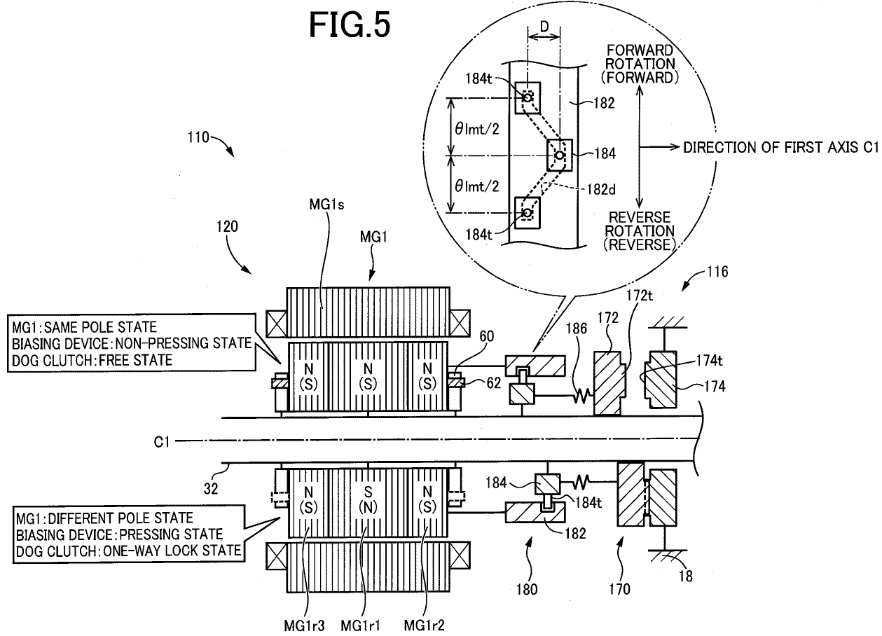

FIG. 5 is a schematic view of a portion of a drive apparatus 120 according to a second embodiment of the present invention. The drive apparatus 120 is mounted on a vehicle 110. The vehicle 110 has substantially the same construction as the vehicle 10 according to the first embodiment described above, except that a power transmission device 116 is provided instead of the power transmission device 16. The power transmission device 116 has substantially the same construction as the power transmission device 16, except that a dog clutch 170 and a biasing device 180 are provided instead of the SOWC 70 and the selector 80. Therefore, in this second embodiment, only the dog clutch 170 and the biasing device 180 will be described, and descriptions of other constructions will be omitted as appropriate. Furthermore, portions that are substantially the same in function as those in the first embodiment will be assigned the same reference numerals, and descriptions will be omitted as appropriate. In FIG. 5, the portion on the upper side of the first axis C1 represents the same pole state of the first electric motor MG1, and the portion on the lower side of the first axis C1 represents the different pole states of MG1. The drive apparatus 120 is constituted by the above-described engine 12, first electric motor MG1, second electric motor MG2 and power transmission device 116, wherein the engine 12, first electric motor MG1 and second electric motor MG2 serve as power sources.

In FIG. 5, the area surrounded by two-dot chain line is a view of the biasing device 180 as seen radially from the first axis C1 side to the outer periphery, expanded in the circumferential direction, and the rest is a schematic cross-sectional view taken in a plane containing the first axis C1.

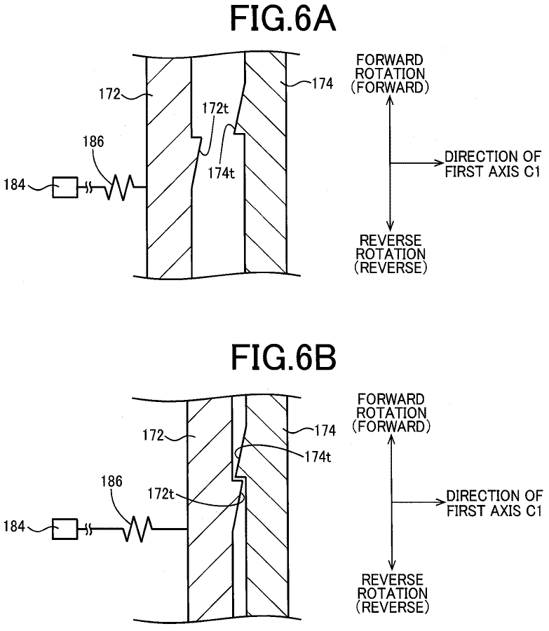

The dog clutch 170 functions as a selectable one-way clutch. The dog clutch 170 has a pressing member 172 and a pressed member 174 that face each other in the direction of the first axis C1. The dog clutch 170, the pressing member 172 and the pressed member 174 correspond to the “engagement device”, “first member” and “second member” in this invention, respectively. The pressing member 172 and the pressed member 174 also correspond to “one of the first member and the second member” and “another of the first member and the second member,” respectively. The pressing member 172 is a rotary member which is connected to the first rotor shaft 32 so as to be unrotatable relative to the first rotor shaft 32 and which is movable in the direction of the first axis C1. The pressed member 174 is an unrotatable member which is connected to the casing and which is unmovable in the direction of the first axis C1. The pressing member 172 has an engagement tooth 172t on its surface facing the pressed member 174, protruding toward the pressed member 174. The pressed member 174 has an engagement tooth 174t on its surface facing the pressing member 172, protruding toward the pressing member 172. The engagement tooth 172t and the engagement tooth 174t are engageable with each other and correspond to “engagement portions” in this invention. When the opposing surfaces of the pressing member 172 and the pressed member 174 come into contact with each other, the engagement tooth 172t is engaged with the engagement tooth 174t, thereby placing the dog clutch 170 in the one-way lock state. It is noted that, as shown in FIG. 6, the engagement tooth 172t is shaped to be engaged with the engagement tooth 174t only in the forward direction. When the opposing surfaces of the pressing member 172 and the pressed member 174 are not in contact with each other, the engagement tooth 172t is released from the engagement tooth 174t, so that the dog clutch 170 is placed in the free state. In FIG. 5, the area on the upper side of the first axis C1 represents the free state of the dog clutch 170, while the area on the lower side of the first axis C1 represents the one-way lock state of the dog clutch 170.

The biasing device 180 switches the operation state of the dog clutch 170 between the one-way lock state and the free state, in conjunction with the drive state of the first electric motor MG1. The biasing device 180 corresponds to “switch mechanism” in this invention. The “one-way lock state” is one of the operation states of the dog clutch 170, which inhibits one direction of relative rotation of the pressing member 172 relative to the pressed member 174. The “free state” is one of the operation states of the dog clutch 170, which allows relative rotation of the pressing member 172 relative to the pressed member 174 in both directions.

The biasing device 180 includes a rotary member 182, a moving member 184 and an elastic member 186. The rotary member 182 is, for example, a cylindrical member centered on the first axis C1, and is connected to the pivotable rotor core MG1r2 so as to be unrotatable relative to the pivotable rotor core MG1r2 and unmovable in the direction of the first axis C1. An engagement groove 182d is provided on the inner periphery of the rotary member 182. The moving member 184 is, for example, a cylindrical member centered on the first axis C1, and is connected to the first rotor shaft 32 so as to be unrotatable relative to the pivotable rotor core MG1r2 and movable in the direction of the first axis C1. An engagement protrusion 184t is provided on the outer periphery of the moving member 184. The engagement protrusion 184t is engaged with the engagement groove 182d and is movable within the engagement groove 182d. The engagement groove 182d is shaped to cause the moving member 184 to be moved in the direction of the first axis C1 in conjunction with the phase difference Δθ. Specifically, the engagement groove 182d extends from a groove position in which the engagement protrusion 184t is engaged with the engagement groove 182d in the different pole state, in a direction of the forward rotation toward the pivotable rotor core MG1r2. Further, the engagement groove 182d extends from the groove position in which the engagement protrusion 184t is engaged with the engagement groove 182d in the different pole state, in a direction of the reverse rotation toward the pivotable rotor core MG1r2. The biasing device 180 converts the phase difference Δθ into the position of the moving member 184 in the direction of the first axis C1. In conjunction with the phase difference Δθ, the moving member 184 is moved in the direction of the first axis C1 within a range of movement distance D [m]. The moving member 184 is connected to the pressing member 172 through the elastic member 186. The elastic member 186 is, for example, a compression coil spring wound spirally around the axis C1. With the phase difference Δθsame, the moving member 184 is moved toward the pivotable rotor core MG1r2 in the direction of the first axis C1 and is not pressed against the pressing member 172. With the phase difference Δθdif, the moving member 184 is moved away from the pivotable rotor core MG1r2 in the direction of the first axis C1 and is pressed against the pressing member 172. When the dog clutch 170 is in the one-way lock state described below and the pressing member 172 is rotated in the reverse direction, the elastic member 186 absorbs the force by which the pressing member 172 is repelled by the pressed member 174 toward the moving member 184, thereby suppressing the movement of the moving member 184 in the direction of the first axis C1. In FIG. 5, the area on the upper side of the first axis C1 represents a non-pressing state in which the biasing device 180 does not press the pressing member 172 against the pressed member 174, while the area on the lower side of the first axis C1 represents a pressing state in which the biasing device 180 presses the pressing member 172 against the pressed member 174.

FIGS. 6A and 6B are views for explaining a construction of the dog clutch 170, wherein FIG. 6A shows the non-pressing state of the biasing device 180 and FIG. 6B shows the pressing state of the biasing device 180. In the non-pressing state of FIG. 6A, the pressing member 172 and the pressed member 174 are not in contact with each other so that the dog clutch 170 is in the free state. In the pressing state of FIG. 6B, the pressing member 172 and the pressed member 174 are in contact with each other, so that the dog clutch 170 is in the one-way lock state. The engagement tooth 172t is shaped to be engage with the engagement tooth 174t only in the forward direction.

In this second embodiment, owing to the same construction as the above-described first embodiment, the same effects as the first embodiment are achieved in accordance with the same construction.

In this second embodiment, the drive apparatus 120 includes: (i) the first electric motor MG1; (ii) the dog clutch 170 including the pressing member 172 connected to the first rotor shaft 32, unrotatable relative to the first rotor shaft 32 and movable in the direction of the first axis C1, and the pressed member 174 connected to the casing 18 and centered on the first axis C1; and (iii) the biasing device 180 configured to switch the operation state of the dog clutch 170 between the one-way lock state and the free state, in conjunction with the drive state of the first electric motor MG1, wherein (a) the engagement teeth 172t, 174t are provided on the opposed surfaces of the pressing and pressed members 172, 174 so as to be engaged with each other, (b) the pressing and pressed members 172, 174 are placed in the one-way lock state when the engagement teeth 172t, 174t are engaged with each other, (c) the pressing and pressed members 172, 174 are placed in the free state when the engagement teeth 172t, 174t are released from each other, (d) the biasing device 180 is configured to cause the engagement teeth 172t, 174t to be engaged with each other by pressing the pressing member 172 against the pressed member 174 and to cause the engagement teeth 172t, 174t to be released from each other by not pressing the pressing member 172 against the pressed member 174, and (e) the biasing device 180 includes the moving member 184 that is to be moved in the direction of the first axis C1 in conjunction with the phase difference Δθ. With the constructions (ii), (a)-(c), the state of the first rotor shaft 32 connected to the pressing member 172 and the pressed member 174 connected to the casing 18 is switched by the engagement teeth 172t, 174t. With the constructions (d)-(e), the moving member 184 of the biasing device 180 is moved in the direction of the first axis C1 in conjunction with the phase difference Δθ, whereby the engagement teeth 172t, 174t are engaged with each other and are released from each other. Thus, the connection/disconnection state of the pressing and pressed members 172, 174 is switched whereby the dog clutch 170 switched between the one-way lock state and the free state. Since the moving member 184 is moved in conjunction with the phase difference Δθ, the drive apparatus 120 is capable of causing the operation state of the dog clutch 170 to be switched in conjunction with the drive state of the first electric motor MG1, without needing an actuator.

The above-described embodiments of the present invention are merely examples, and the present invention can be embodied in various forms with various modifications and improvements made based on the knowledge of those skilled in the art without departing from the spirit of the present invention.

In the above-described first and second embodiments, the two pivotable rotor cores MG1r2, MG1r3 are arranged adjacent to both sides of the fixed rotor core MG1r1 in the direction of the first axis C1. However, the present invention is not limited to this detail. For example, the present invention is also applicable to an arrangement in which only one pivotable rotor core MG1r2 is provided adjacent to the fixed rotor core MG1r1 on one side in the direction of the first axis C1.

In the above-described first and second embodiments, the “first member” in the present invention is the outer ring 72 or the pressing member 172, and the “second member” in the present invention is the inner ring 74 or the pressed member 174. However, the present invention is not limited to this detail. For example, the “first member” may be the inner ring 74 or the pressed member 174, and the “second member” may be the outer ring 72 or the pressing member 172. For example, in the first embodiment, the inner ring 74 may be connected to the first rotor shaft 32, the outer ring 72 may be connected to the casing 18, and the connection/disconnection devices 76 may include recesses recessed toward the inner periphery on the outer periphery of the inner ring 74, and the pawls provided in the recesses and biased by springs so as to protrude toward the outer periphery, i.e., toward the outer ring 72. In this case, the selector 80 is rotated in synchronization with the inner ring 74, and the rotation state of the selector 80 is in the allowing state that allows the pawls to protrude or the inhibiting state that inhibits the pawls from protruding. For example, in the second embodiment, this is the case in which the pressed member 174 is connected to the first rotor shaft 32 and the pressing member 172 is connected to casing 18 so as to be movable in the direction of first axis C1.

In the above-described second embodiment, the “engagement portions” in the present invention corresponds to the engagement tooth 172t and the engagement tooth 174t provided on the opposing surfaces of the pressing member 172 and the pressed member 174, respectively, but the present invention is not limited to this detail. For example, the “engagement portions” may be constituted by an engagement tooth provided on one of the opposing surfaces of the pressing member 172 and the pressed member 174, and a recess that is to be engaged with the engagement tooth provided on the other. In the second embodiment, the rotary member 182 is provided with the engagement groove 182d, and the moving member 184 is provided with the engagement protrusion 184t, but the present invention is not limited to this detail. For example, the rotary member 182 may be provided with an engagement protrusion, and the moving member 184 may be provided with an engagement groove. In the second embodiment, the rotary member 182 is connected to the pivotable rotor core MG1r2 so as not to be rotatable relative to the pivotable rotor core MG1r2, and the moving member 184 is connected to the first rotor shaft 32 so as not to be rotatable relative to the first rotor shaft 32 and so as to be movable in the direction of the first axis C1. However, the present invention is not limited to this detail. For example, the rotary member 182 may be connected to the first rotor shaft 32 so as not to be rotatable relative to the first rotor shaft 32 and so as not to be movable in the direction of the first axis C1, and the moving member 184 may be connected to the pivotable rotor core MG1r2 so as not to rotatable relative to the pivotable rotor core MG1r2 and so as to be movable in the direction of the first axis C1. In other words, the present invention is also applicable to an arrangement in which the moving member 184 is connected to one of the first rotor shaft 32 and the pivotable rotor core MG1r2 so as not to be rotatable relative to the one of the first rotor shaft 32 and the pivotable rotor core MG1r2 and so as not to be movable in the direction of the first axis C1, and the rotary member 182 is connected to the other of the first rotor shaft 32 and the pivotable rotor core MG1r2 so as not to rotatable relative to the other of the first rotor shaft 32 and the pivotable rotor core MG1r2 and so as to be movable in the direction of the first axis C1,

In the above-described first and second embodiments, “the one of the connection and disconnection states” in the present invention is the one-way lock state, while “the other of the connection and disconnection states” in the present invention is the free state. However, the present invention is not limited to this detail. For example, where the construction of vehicle 10 is different, “the one of the connection and disconnection states” may be the free state, while “the other of the connection and disconnection states” may be the one-way lock state. For example, in the first embodiment, the opposed portions 80t of the selector 80 may be provided such that the rotation state of the selector 80 is set to the allowing state in conjunction with the phase difference Δθdif and the rotation state of selector 80 is set to the inhibiting state in conjunction with the phase difference Δθsame. For example, in the second embodiment, the shape of the engagement groove 182d of the rotary member 182 may be formed such that the biasing device 180 is placed in the non-pressing state in conjunction with phase difference Δθdif and is placed in the pressing state in conjunction with the phase difference Δθsame. For example, the shape of the engagement groove 182d shown within the two-dot chain line in FIG. 5 may be reversed between the pivotable rotor core MG1r2 side and the dog clutch 170 side in the direction of the first axis C1.

In the above-described first and second embodiments, “the other of the connection and disconnection states” of the present invention is the one-way lock state that inhibits the forward direction, but the present invention is not limited to this detail. For example, where the construction of the vehicle 10 is different, “the other of the connection and disconnection states” may be a one-way lock state that inhibits the reverse direction, or may be a bidirectional lock state that inhibits both of the forward and reverse directions. For example, in the first embodiment, the direction in which the pawls 76p are to be rotated in the connection/disconnection devices 76 may be the opposite direction to that in the first embodiment, or the connection/disconnection devices 76 may have bidirectional directions in which the pawls 76p are to be rotated, and the rotation state of the selector 80 may be the allowing state or the inhibiting state for the pawls 76p that are to rotates in both directions. For example, in the second embodiment, the engagement teeth 172t, 174t may be shaped to inhibit the rotation in only the reverse direction, or to inhibit the rotation in both of the forward and reverse directions.

In the above-described first and second embodiments, the “second member” in the present invention is the casing 18, which is a unrotatable member, but the present invention is not limited to this detail. For example, where the construction of the vehicle 10 is different, the “second member” may be a rotary member.

In the above-described first and second embodiments, the selector 80 and the rotary member 182 of the biasing device 180 are connected to only the pivotable rotor core MG1r2, which is one of the pivotable rotor cores MG1r2, MG1r3. However, the present invention is not limited to this detail. For example, (a) the fixed rotor core MG1r1 may be provided with a through-hole penetrating in the direction of the first axis C1, and (b) the pivotable rotor cores MG1r2, MG1r3 may be connected to each other through by a member passing through the through-hole, such that the selector 80 and the rotary member 182 of the biasing device 180 are connected to both of the pivotable rotor cores MG1r2, MG1r3.

NOMENCLATURE OF ELEMENTS 10,110: vehicle 12: engine 16,116: power transmission device 20,120: drive apparatus 22: planetary gear device (power split mechanism) 32: first rotor shaft 70: SOWC (engagement device) 72: outer ring (one of first and second members) 74: inner ring (another of the first and second members) 76: connection/disconnection devices 76p: pawl (protrusion portion) 80: selector (switch mechanism) 170: dog clutch (engagement device) 172: pressing member (one of first and second members) 172t: engagement tooth (engagement potion) 174: pressed member (another of first and second members) 174t: engagement tooth (engagement potion) 180: biasing device (switch mechanism) 184: moving member

C1: first axis (axis)

MG1: first electric motor

MG1r: rotor core

MG1r1: fixed rotor core (fixed rotor core)

MG1r2: pivotable rotor core

MG1r3: pivotable rotor core

MG1rm: permanent magnet

MG1s: stator

MG2: second electric motor

Tmg1: MG1 torque (output torque)

Δθ: phase difference θlmt: specified angle range

What is claimed is:

1. A drive apparatus for a vehicle, the drive apparatus comprising:
a first electric motor including a cylindrical stator disposed on an axis, a rotor shaft disposed on an inner peripheral side of the stator and extending in a direction of the axis, and a rotor core disposed between the stator and the rotor shaft and including a permanent magnet;
an engagement device including a first member connected to the rotor shaft and unrotatable relative to the rotor shaft and a second member that is to be selectively connected to and disconnected from the first member; and
a switch mechanism configured to switch an operation state of the engagement device between connection and disconnection states in conjunction with a drive state of the first electric motor, such that the second member is connected to the first member in the connection state, and such that the second member is disconnected from the first member in the disconnection state,
wherein the rotor core includes a fixed rotor core fixed to the rotor shaft and unrotatable relative to the rotor shaft about the axis and a pivotable rotor core disposed adjacent to the fixed rotor core in the direction of the axis and pivotable relative to the fixed rotor core within a predetermined angle range about the axis,
wherein the drive sate of the first electric motor is to be switched, in accordance with an output torque of the first electric motor, between a different pole state and a same pole state, such that magnetic poles appearing on respective surfaces of the fixed rotor core and the pivotable rotor core, which are adjacent to each other in the direction of the of the axis, are different poles from each other in the different pole state, and such that the magnetic poles appearing on the respective surfaces are the same poles as each other in the same pole state,
wherein a phase difference between the fixed rotor core and the pivotable rotor core is determined in accordance with the drive state of the first electric motor; and
wherein the switch mechanism is configured to place the engagement device into one of the connection and disconnection states in conjunction with the phase difference when the first electric motor is in the different pole state, and is configured to place the engagement device into another of the connection and disconnection states in conjunction with the phase difference when the first electric motor is in the same pole state.

2. The drive apparatus according to claim 1,
wherein the engagement device includes an outer ring which is one of the first and second members and which is disposed on the axis, an inner ring which is another of the first and second members and which is disposed on the axis, and a connection/disconnection device configured to switch between the connection and disconnection states,
wherein, when a protrusion portion protrudes from one of the outer and inner rings towards another of the outer and inner rings, the connection/disconnection device is configured to place the outer and inner rings in the one of the connection and disconnection states,
wherein, when the protrusion portion does not protrude from the one of the outer and inner rings towards the other of the outer and inner rings, the connection/disconnection device is configured to place the outer and inner rings in the other of the connection and disconnection states, and
wherein the switch mechanism includes a selector which is to be rotated in synchronization with the first member, and which is configured to allow and inhibit protrusion of the protrusion portion of the connection/disconnection device, in conjunction of the phase difference.

3. The drive apparatus according to claim 1,
wherein the engagement device includes a pressing member which is one of the first and second members and a pressed member which is another of the first and second members, such that the pressing member and the pressed member are opposed to each other in the direction of the of the axis,
wherein the pressing member and the pressed member include engagement portions which are provided on surfaces thereof opposed to each other and which are to be engaged with each other,
wherein the pressing member and the pressed member are placed in the one of the connection and disconnection states when the engagement portions are engaged with each other, and are placed in the other of the connection and disconnection states when the engagement portions are released from each other,
wherein the switch mechanism is a biasing device which is configured to cause the engagement portions to be engaged with each other by pressing the pressing member against the pressed member and to cause the engagement portions to be released from each other by not pressing the pressing member against the pressed member, and
wherein the biasing device includes a moving member that is to be moved in the direction of the axis in conjunction of the phase difference.

4. The drive apparatus according to claim 1,
wherein the one of the connection and disconnection states is a one-way lock state in which relative rotation of the first and second members in one of opposite directions is inhibited, and
wherein the other of the connection and disconnection states is a free state in which the relative rotation of the first and second members in both of the opposite directions is allowed.

5. The drive apparatus according to claim 4, further comprising:
an engine;
a second electric motor; and
a power split mechanism,
wherein the engine and the first electric motor are connected to the power split mechanism such that a power of the engine is split between the first electric motor and a pair of dive wheels of the vehicle,
wherein the second electric motor is connected to a power transmission path between the power split mechanism and the drive wheels, in a power transmittable manner, and
wherein the one-way lock state is a state in which the relative rotation of the first and second members in a forward direction is inhibited to inhibit the vehicle from running in a forward direction.
